(19) United States
(12) Patent Application Publication
(10) Pub. No.: US 2025/0390784 A1
(43) Pub. Date: Dec. 25, 2025

(54) METHOD AND A SYSTEM FOR TRAINING A TASK SPECIFIC ENGINE

(71) Applicant: Carnegie Robotics, LLC, Pittsburgh, PA (US)

(72) Inventors: John Paul Thomas ATKINSON, Pittsburgh, PA (US); Vivekjyoti BANERJEE, Pittsburgh (PA)

(21) Appl. No.: 18/749,060

(22) Filed: Jun. 20, 2024

(51) Int. Cl. G06N 20/00

(52) U.S. Cl. CPC G06N 20/00

(57) ABSTRACT

A method and apparatus for training a task specific engine such that the task specific engine is first trained on set of labelled data. The labelled data is fed through the task specific engine once more. A performance score for each piece of data fed through the task specific engine is then generated. An embedding engine is then utilized to find further data that is similar to the pieces of labelled data with a low performance score. The further data is then labelled and used to further train the task specific engine with the aim of improving the overall performance of the task specific engine. Labelled data with high performance scores may also be grouped by the embedding engine and similar or duplicate data removed before further training the task specific engine on the reduced set of data.

### FIELD OF THE INVENTION

The present invention relates to training a task specific engine and more particularly to the improving of the training data for training the task specific engine.

Machine learning (ML) is ubiquitous but the training thereof is often not as simple as the use of the final ML engine. Training of a ML system requires a training set which represents the relevant types of input with a sufficient granularity. A ML system not well trained will not function well, even though the user may not realize this.

Two different problems may be encountered. On the one hand, the training set may have “holes” where a portion of the assumed or possible input data is not well represented. Thus, not training the ML in this area may make it poorly equipped to operate on such data. On the other hand, a large amount of similar data may be presented during training so that so-called over training or over fitting may be seen, which also will make the ML system operate suboptimally.

Thus, a need exists for increasing the quality of the training set of the task specific engine or ML system.

### SUMMARY

Assessing similarity between data elements, and adding or removing those data elements from the training set is a known technology. The present invention differs from the prior art in that the addition and/or deletion of data elements in the training set of the task specific engine or ML system may be directly guided by observations of the performance of the task specific engine or ML system.

So, in a first aspect the present invention relates to a method of training a task specific engine, the method comprising:
a. providing a set of labelled data, the set comprising training data,
b. initially training the task specific engine using the training data to obtain an initially trained task specific engine,
c. inputting at least part of the labelled data into the initially trained task specific engine and generating a task specific performance score for each piece of inputted labelled data,
d. identifying inputted labelled data with a task specific performance score below a threshold and inputting the identified labelled data into an embedding engine, the embedding engine being configured to represent high dimensional data in a low dimensional representation,
e. inputting further data into the embedding engine,
f. from an output of the embedding engine, determining further data similar to the identified labelled data,
g. obtaining labelling for each determined further data to generate further training data comprising the determined further data and the labelling for it,
h. further training the task specific engine using the further training data.

In this context, the task specific engine receives data as an input and generates an output based on the input data.

In this context, training refers to teaching a task specific engine by exposing pieces of example data to it and comparing the output from the task specific engine to a known result associated with the example data. In this context training is an iterative process and throughout the process of teaching, parameters associated with the task specific engine may be updated. The parameters may be updated after the task specific engine has been exposed to a single piece of example data, or after being exposed to several pieces of example data (known in the art as a batch). Updating the parameters continues until a stopping condition has been met. Numerous stopping conditions exist, e.g., result of the task specific engine matches, or is desirably close to, the known results associated with the example data. Alternatively, the stop condition could be if the training has been running for a certain amount of time, the task specific training engine has been exposed to all available pieces of data, a certain number of updates have taken place, the learning rate drops below a threshold or the like. Once training is complete, the task specific engine may be referred to as a trained task specific engine.

Furthermore, in this context it is desirable if the trained task specific engine can extrapolate its learning and output appropriate results for input data that it is not trained on but which is of a similar type to the training data.

Thus, using a trained task specific engine may have the benefit that data can be analyzed autonomously (i.e., without need for human intervention).

To train the task specific engine, a set of labelled data is provided. In this context, the set of labelled data comprises a set of input data and a corresponding known result (hereby termed label) for each of the pieces of the input data.

In some applications it may be necessary to have more than one type of label for each piece of training data. The label may be considered a way of annotating the equivalent data. In other words, the label may represent the expected/desired outcome of the trained task-specific engine when presented to the pertaining piece of data. The label may take the form of a text, an image, a sound, a bounding box, a segmentation mask, or the like. It may also be a combination of text, image, sound, a bounding box, a segmentation mask or the like. Then, a label may represent any information which may be derived and/or desirable from the piece of data.

For example, the inputted data may be in the form of an image, and the corresponding label may be a text string annotating whether a human, or any other physical element, is present in the image or not. Furthermore, or alternatively, the label may also contain or represent coordinates as to the location of the human in the image. Furthermore, or alternatively, the label may contain or represent a text string describing the stance of the person. Furthermore, or alternatively, the label may contain or represent a text string describing a hair color of the person.

Another example may be that the inputted data may be in the form of sound data, wherein the sound is a recording of e.g. machinery, where the label may be in the form of a text string annotating if the machine is faulty, operating, or the like. Furthermore, or alternatively, the label may comprise or represent the type of fault, operation or the like. Furthermore, or alternatively, the label may comprise or represent the location of the fault within the machine. Furthermore, or alternatively, the label may comprise or represent at what time stamp throughout the sound data sample the fault was most recognizable.

In another instance the training data could be text in one language and the label could be text in another language. The training data may be sound data of someone talking in one language and the corresponding label could be sound data in the other language. The training data may be a sound clip and the label a text string or vice versa. To generate the label a bilingual speaker may be required to read or listen to the training data and speak or write the translations, i.e., the label.

In a further example, the training data may be in the form of instructions that a robot should follow to achieve a determined location of the robot or its end effector, the label may be the location of the robot or the end effector. This label could be text string of the coordinates. Alternatively, the label could be a picture of the robot wherein the location of the robot or the end effector could be determined. Alternatively, the labels may be a vector of numbers describing the location of the robot or the end effector. The labels may be generated by a human, or may be generated algorithmically from knowledge of the robot kinematics, the position and imaging characteristics of a camera that is regarding the robot, etc.

Furthermore, in another example, the task specific engine may be required to predict the weather based on the weather data from the previous days' weather. In this instance the training data may be the temperature and wind speed of five previous days and the label could be the temperature and wind speed on the 6th day. In this example a human would not necessarily be required to provide a label.

It is traditional that the label data is generated manually. It may also be generated through use of an existing artificial intelligence or using augmented training data. Tools exist which may determine the presence, position, stance, and the like of predetermined elements of e.g. images. Such tools may be used for labelling data.

The set of labelled data is or comprises a subset of the labelled data referred to as training data. The training data comprise a set of pieces of input data and corresponding labels. Some of the labelled data that are not part of the training data, if such data exist, may be used to assess how well the task specific engine can extrapolate to data it had not been exposed to during training.

To clarify further, a set of training data may comprise a number of pieces of example data and the same number of labels corresponding to the pieces of example data.

Using the training data, initial training of the task specific engine is carried out. In this context, initial training means that the task specific engine is trained using the training data, however there is the intent to further train the task specific engine at a later step in the method. The result of the initial training is an initially trained task specific engine.

The success of the initially trained task specific engine is measured by inputting at least part of the labelled data into the initially trained task specific engine. In this context the at least part of the labelled data may comprise all available labelled data, it may be the training data or it may be part of the training data. Alternatively, the at least part of the labelled data may be part of the labelled data that is not used for training. Furthermore, the at least part of the labelled data may be a combination of any of the above examples.

To quantify the success of the initially trained task specific engine a task specific performance score is used. For each piece of labelled data inputted to the initially trained task specific engine, a performance score is generated in step c. In this context, the performance score is based on the difference between the output of the initially trained task specific engine, when the labelled data is input, and the label of the labelled data. This difference or performance score is generated for each piece of data in the labelled data set used during step c. If the initially trained task specific engine is well trained, there will be little difference between the outputs of the initially trained task specific engine and the labels of all the labelled data inputted to the initially trained task specific engine.

For some pieces of data in the inputted data utilized in step c, the initially trained task specific engine may output a close match to the inputted data's label. However, for some of the other pieces of data in the inputted data set in step c, the initially trained task specific engine may output a poor match to the inputted data's label. In other words, the initially trained task specific engine may be deemed inconsistent in its performance. Generally, this may indicate that the initially trained task specific engine may be improved by the further training.

Pieces of labelled inputted data (i.e., those inputted into the task specific engine in step c) with task specific performance scores below a threshold, i.e. ones with a less good match, may be identified. In this context the threshold is a predetermined value which may select labelled data having a sufficiently poor match.

The value of the threshold may be calculated in any desired manner, such as:
so that a predetermined portion or percentage of the labelled data is identified,
so that a statistically representative portion of the poorly performing labelled data, such as a lowest quantile, is selected,
so that all labelled data with performance scores less than a percentage of the highest performance score are identified,
the engine generates a likelihood of a match, the threshold relating to the likelihood,
or the like.

Note that the threshold may be dynamically varied so that, in the case where the output of the task specific engine has a predicted performance score, all labelled data with performance scores lower than the predicted performance score are selected.

The identified pieces of training data are then inputted into the embedding engine. In this context, the embedding engine represents high dimensional data in a low dimensional representation.

An embedding network is a neural network that maps a high dimensional data representation to a lower dimensional one, while retaining some semantic information. In the context of neural networks, embeddings are low-dimensional, learned continuous vector representations of a higher dimensional data representation. Neural network embeddings are useful because they can reduce the dimensionality of data and meaningfully represent the data in the transformed space. Embedding neural networks are applied to many different problems and applications, typically where an input containing many dimensions needs to be mapped to a low dimensional space. Examples of this include mapping books and articles to topic categories, or mapping/grouping images according to contents and composition. The results of embedding networks are often used to identify similarities in different inputs (articles, sound, images, etc.). An application of this in content-recommendations is to find similar books, songs or images that can then be presented as potential matches to a favored item. This mapping from a high dimensional space to a low dimensional space is called an embedding. The embedding networks produce embeddings. Some embeddings have meaningful dimensions, such as a genre for a book, but often the embedding dimensions (low dimensional output) do not have any human meaning. Obviously, this can also be applied for identifying images with similar contents.

In other words, high dimensional data may be inputted into the embedding engine where the embedding engine will output a representation of the data in a lower dimension. Using an embedding engine may have the benefit of identifying similarities between data that is inputted into the embedding engine, as these similarities may be easier to observe, calculate and/or identify in the lower dimension space. Thus, data that is similar to the identified training data for which the initially trained task specific engine produces a poor task specific performance score can be more easily identified. This similar data can then be used to further train the initially trained task specific engine with the aim of improving the overall performance thereof by providing more examples of the data it previously performed poorly on.

It is noted that the embedding network need not be, and usually is not, trained to the particular purpose or task of the task specific engine. Even though the embedding network will then be more generally representing the high dimensional data into the lower dimension, the purpose of the embedding network will still be fulfilled. For example, it is not required that the embedded network derives data relating from the labels from the input data.

In general, it is known to those skilled in the art, that when training an engine such as the task specific engine, the more examples/pieces of training data exposed to the engine, and the larger the variation thereof, the better the engine becomes at generating results that match each of the labels of the pieces of the training data, and generalizing those results to new inputs.

Furthermore, there may be some pieces of input data with certain features that the task specific engine performs poorly on compared with the overall task specific engine performance. Therefore, exposing the task specific engine to more pieces of data with these certain features, or similar in other manners, may increase the performance of the task specific engine in this area (and consequently overall).

Therefore, it is beneficial to identify more pieces of input data with similar features to the identified training data to expose to the initially trained task specific network in order to improve the overall performance. These features may not be obvious to the human eye and therefore it is beneficial to use an embedding engine.

To identify data that is similar to the identified training data, the further data is inputted into the embedding engine. In this context, the further data is data not used in the initial training of the task specific engine. It may be labelled data (i.e., have a corresponding known result) but it may also be unlabeled (i.e., without corresponding known result).

The output of the embedding engine may be a low dimension representation of the identified labelled data and the further data as generated by the embedding engine. This low dimension representation may more easily allow similar identified training data and further data to be identified. This identification could be achieved by measuring the distance between two low dimension representations of respective elements of the identified training data and the further data, and if the distance is below a predetermined value the training data and the further data may be deemed similar. Various types of distances exist such as Euclidean distance, cosine difference, hamming distance, Manhattan, Minkowski, or the like. The identification could also utilize a clustering algorithm, such as density-based, distribution based, Centroid-based, hierarchical-based, k-means or the like.

It is known to those skilled in the art that too much of the same type of data (i.e., with the same features) may cause overfitting of an engine, such as the task specific engine. Overfitting refers to when an overrepresentation of some input-areas has caused the optimization/training to predominantly focus on those areas, other areas with less input density are underemphasized in the training. Thus, the engine may be unable to sufficiently generalize its learning to some types of new (i.e., not seen during training) data.

Therefore, it may be advantageous to only identify a percentage of the further data that is similar to the identified training data. If too much data with similar features is identified as further data, and this is used to further train the network, there is a risk of overfitting. This process is known in the art as “data deduplication.” The present invention differs from the prior art in that data deduplication may be directly guided by the performance of the task specific engine, so that deduplication efforts are applied only where they are most useful.

Further data that is similar to the identified training data is termed determined further data.

Since it is desired to use the determined further data to further train the task specific engine, it is necessary to label any unlabeled pieces of data in the determined further data set. In this context labelling is adding or attaching a label to a corresponding piece of determined further data. The labelled determined further data is now referred to as further training data.

The further training data is used to further train the initially trained task specific engine. In this context to further train means exposing the pieces of further training data to the initially trained task specific engine and comparing the output from the initially trained task specific engine to a known results (labels) associated with the further training data. As with the initial training of the task specific engine the parameters associated with the initially trained task specific engine are updated.

When further training the initially trained task specific engine, the values for the parameters found during the initial training may be used as a starting point, i.e., the task specific engine starts with the parameter values, i.e. as the initially trained task specific engine, and these are updated during the further training. In this instance, either the initially trained task specific engine may be exposed to just the further training data identified during the further training, or it may be exposed to both the initial training data and the further training data.

Alternatively, the parameters of the initially trained task specific engine may be reset, zeroed, potentially randomized or the like, before further training commences. In this case, it is likely most beneficial if the task specific engine is exposed to both the initial training data and the further training data.

After further training, the task specific engine is now termed trained task specific engine.

Note that steps c-h may be repeated multiple times. The repetition of steps c-h may aim to produce a higher performing engine, compared with one iteration of steps c-h.

Clearly, the above method of training a task specific engine may be used for training any task specific engine, such as a neural network. The method generally relates to the determination of data on which the task specific engine does not perform its task well, the automated determination of further data somehow similar to the data that causes poor performance of the task specific engine, and the use of this further data to further train the task specific engine.

Then, any application involving a task specific engine may advantageously make use of the method.

The initial training of the task specific engine may be performed on any desired data. This data need not, but may very well, stem from the application in which the task specific engine is eventually to be used. In addition, the further data need not stem from that application either, even though this may also be an advantage, as it would then with a higher probability be relevant to the engine and thus with a higher probability increase the usefulness of the engine.

It is noted that task specific engines are used for a multitude of purposes, such as for navigation, manufacture, quality control, object detection, object identification, scene segmentation, other vision tasks, error or fault detection, defect detection, and identification of deviation from a defined volume, weight, status, quality or other parameter.

In one situation, the task specific network is used in relation to operation of a vehicle having a camera providing data for entry into the task specific engine. The operation may be navigation, error detection or the like. Thus, step e. may comprise receiving, as the further data, first image data from the camera of the vehicle, where the method further comprises, after step h, the steps of receiving second image data from the camera, feeding the second image data into the task specific engine, receiving an output of the task specific engine and operating the vehicle based on the received output.

In general, the image data from the camera may be fed live into the task specific engine, or it may be stored or logged and used at a later stage. Then, step e. may instead or additionally comprise obtaining first image data from collections of images in previously-logged camera data.

In this situation, the further data stems from the camera and thus will be relevant for the operation of the vehicle. As mentioned above, the operation may be navigation based on the image data, whereby the engine may assist in the navigation, such as the determination of a position, direction, pose, velocity, acceleration, or the like of the vehicle, the identification, classification or the like of obstacles in a vicinity of the vehicle or the like. Alternatively, the camera may be used for surveillance of surroundings of the vehicle, which may travel in a space or venue. The engine may thus be set for determining irregularities or deviations from a usual state of the space or venue, such as identifying persons, or with particular clothing, missing or added elements in the surroundings and the like.

The further data thus stems from the camera of the vehicle and may be labelled and used in the further training of the engine.

In another situation, the camera may be viewing a moving object, such as a train, conveyor belt, rotating element, vehicle, airplane, robot arm or the like. Usually, the movement is relative to the camera, but as the camera may also move in relation to e.g. a wall or support thereof, the movement may be in relation to any desired coordinate system, such as that of the earth.

The engine may then be used for operating the moving object or for analyzing the moving object, such as fault detection, error detection, deviation from a desired envelope, such as of a movement of the moving object, quality check or the like.

In this situation, step e. comprises receiving, as the further data, first image data, live or previously logged, from a camera imaging a moving object, where the method further comprises, after step h, the steps of receiving second image data from the camera, feeding the second image data into the task specific engine, receiving an output of the task specific engine and outputting, based on the received output, information relating to the moving object. Naturally, in this situation and those mentioned below, the second image data may be fed live to the task specific engine or it may be logged between generation and feeding to the task specific engine.

Again, the further data stems from the camera and thus will represent what the camera sees also during normal operation. Thus, unexpected, or undesired movements may be visible in the further data and may be used in the further training. The task specific engine may then generate information relating to a movement of the object, such as with reference to a desired or intended movement thereof.

Alternatively, the information generated may relate to the actual moving object, such as deviations, errors, faults, or the like thereof. Features of the object may be compared between objects or over time, and the output information may relate to changes or deviations of such features. Thus, this situation may be used in manufacture of identical, or intended identical, products, where inter-product deviations may be identified by the engine and represented in the information output.

A third situation in which the method of the first embodiment is very useful, is one where the camera is mounted on a moving element. In this situation, the engine may be used for operating the moving clement, such as controlling the moving element. The operation of the moving element may be aimed at bringing the camera to a desired position for viewing an item from a particular angle, or the operation may be to e.g. use the moving element during e.g. production where the moving element takes part in the production, such as a robotic arm.

In this situation, step c. comprises receiving, as the further data, first image data from a camera of a moving element, where the method further comprises, after step h, the steps of receiving second image data from the camera, feeding the second image data into the task specific engine, receiving an output of the task specific engine and operating the moving clement based on the received output.

In yet another situation, the further data could be images of a plurality of items, such as images of produced items. In this situation the task specific engine may be used for quality control of the items. Any deviations or missing portions thereof may be identified by the engine, so that the pertaining item may be e.g. discarded. In this situation, the training of the engine may define other parameters of the items which would be acceptable.

In this situation, step e. comprises receiving, as the further data, first image data from a camera of each of a plurality of items, where the method further comprises, after step h, the steps of receiving second image data from the camera, the second image data relating to each of a plurality of further items, feeding the second image data into the task specific engine, receiving an output of the task specific engine and outputting information, based on the received output, relating to each of the further items.

Then, the output information may be used for defining a quality or the like of an item and/or may be used for discarding items being sufficiently faulty.

Naturally, for all above situations, a group, plurality or swarm of vehicles, moving elements or the like may be provided. A task specific engine may be defined for each such vehicle/element or the like, or the same engine may be used across the vehicles/elements. Then, the cameras of one of the vehicles/elements, some thereof-or all of them-may be used for generating the further data. This is especially relevant, if the vehicles or elements all have the same overall structure, such as when the cameras thereof are positioned in similar positions in relation the vehicles/elements.

Above, situations are presented in which the further data stems from a camera. It is clear that the method of the first aspect is equally relevant for handling sensor output, such as voltages/currents, digital signals, or the like. The output of a sensor, such as over time, may reveal a lot of information from a monitored process, such as a manufacturing process or an operating plant of any type. Deviations in sound, vibration, rotation, flow, temperature, pH, pressure or the like may reveal ahead of time that the process or manufacturing is not optimal or will soon become not optimal. Thus, in such situations, the training data will be of a suitable type and the further information could be such sensor information which allows the training of the engine. The labels of such data could relate to the process or manufacturing, such as a quality thereof or a quantification of how well the manufacturing or process is proceeding, such as compared to a perfect or predetermined manufacturing or process.

Below, third and fourth aspects of the invention are described which relate to not adding further data to the training but to identifying and removing superfluous training data, i.e. training data which may be similar to other training data upon which the task specific engine was already trained.

These two methods may be combined so that superfluous training data may be removed before or after the further data is added. These methods may be performed sequentially and potentially multiple times in order to improve the training incrementally.

Then, the method may comprise, after step b, the steps of:
input at least part of the training data into the initially trained task specific engine and generate a performance score for each piece of input training data,
identify inputted training data with a performance score above a threshold,
input the identified training data into an embedding engine, the embedding engine being configured to represent high dimensional data in a low dimensional representation,
from an output of the embedding engine, determine groups of similar identified training data,
from one or more of the determined groups, establish one or more pieces of the similar identified training data and remove the established pieces of data from the initial training data to generate altered training data,
further train the task specific engine using the altered training data.

This method is explained further below. It is noted that in this embodiment, the identified data is identified training data which is data which was used to train the engine. In the situation where the labelled data input in step c. is also training data, these steps will be identical, so one may be left out in the description of the method.

In a second aspect the present invention relates to a system for training a task specific engine, the system comprising:
a storage configured to hold a set of labelled data,
a second storage configured to hold data relating to the task specific engine,
a receiver configured to receive further data,
a third storage configured to hold the further data,
a provider configured to provide labels for data, and
a controller configured to:
   retrieve the labelled data from the first storage and determine a set of initial training data from at least part of the labelled data,
   ii. initially train the task specific engine using the initial training data to obtain an initially trained task specific engine and to generate initial data associated with the initially trained task specific engine; and store the initial data in the second storage,
   iii. input at least part of the labelled data into the initially trained task specific engine and generate, for each input labelled data, a performance score,
   iv. identify the labelled data with a performance score below a threshold and input the identified labelled data into the pre-trained embedding engine, the embedding engine being configured to represent high dimensional data in a low dimensional representation,
   v. receive and store the further data in the third storage,
   vi. input the further data into the pre-trained embedding engine,
   vii. from an output of the embedding engine, determine further data similar to the identified labelled data,
   viii. receive, from the provider, labels for the determined further data, and generate further training data from the labels and the determined further data,
   ix. further train the trained task specific engine using the further training data, and
   x. generate updated data associated with the further trained task specific engine and store the updated data in the second storage.

The task specific engine, labelled data, initial training, initially trained task specific network, further trained task specific network, trained task specific network, embedding engine, further data are all as described above within the first aspect of the invention.

Clearly, any embodiment, situation, consideration and the like described in relation to the first aspect is equally relevant to the second aspect of the invention.

Within this aspect of the invention a first, second and third storage are utilized. The term storage area refers to a place/area configured for the retention of retrievable data. Many types of storage area exist such as a physical hard drive, a disk drive, USB drive or it could be a virtual storage area, for example on the internet in the cloud or such like.

In this context the first storage is configured to hold the set of labelled data. Therefore, the first storage holds the labelled data and the training data. Given that each piece of labelled data comprises a piece of input data and a corresponding label, the storage is configured to hold the pieces of input data and their corresponding labels. The first storage area could be any of the examples listed above.

In this context, the second storage is configured to hold data relating to the task specific engine. The second storage could be any of the examples listed above. In a first instance, this data relating to the task specific engine may be generated by the initial training, the initial training being as described above in relation to the first aspect. The data relating to the task specific engine stored in the second storage may then be updated by further training. Further training is also described above relating to the first aspect.

As previously discussed, in this context, training, both initial and further, is an iterative process and thus the data generated by the initial training, retained in the second storage, may be updated after each iteration of the initial training if also the initial training is iterative. The data generated by initial training may then be updated after the further training. Alternatively, the data generated by the initial training may be reserved, and data generated by the further training stored in addition. Then, the data generated by the further training is updated after the further training whilst the data generated by the initial training remains unchanged. This may be beneficial as if the embedding engine is faulty or produces suboptimal further training data it may be preferred to revert to the initially trained task specific engine.

The system may use storage associated with a GPU, CPU or TPU depending on the type of task specific engine in use. Examples of data stored within the second storage area may be the morphology of a neural network, including locations of nodes and connections etc. Examples of data stored in the second storage may also be the weights of connections and any bias values if used. It may be parameters associated with the task specific engine such as learning rates, activation functions, batch size, stopping conditions or the like. Note that in the case of, for example, learning rates, activation functions, batch size, stopping conditions, these parameters may remain unchanged throughout initial training and further training and therefore are not updated iteratively.

Note that the first and second storage may be the same, for instance, both training data and parameters associated with the task specific engine may be stored in the cloud.

In this context, the receiver is configured to receive further data. In other words, the receiver may be configured to gather data that may then be used to further train the task specific network, as described in relation to the first aspect. The type of receiver is task specific or suitably chosen depending on the type of the further data. The receiver may be an interface to the internet, that is configured to search the internet and download data of an appropriate type to be retained for input into the embedding engine. It may be a wireless communication interface, wherein data can be sent wirelessly to the receiver from a variety of sources, e.g., a swarm of robots. It may be a hardware interface for which a USB stick, physical hard drive or the like can be connected to. It may be an interface for an external virtual storage system.

In this context the third storage is configured to hold the further data received by the receiver. Note that the further data comprises pieces of input data but may or may not comprise labels associated with each of the pieces of input data, as described above with relation to the first aspect of the invention. The third storage area could be any of the examples listed above. The third storage area could be the same as the first and/or second storage areas.

In this context, the provider is configured to provide labels for the data. Therefore, any identified further data that may not already have a label can be provided one by the provider thus enabling the identified further data to be used in further training. If the identified further data already has an associated label, the provider is not needed or need not provide one. The provider may be a user interface allowing a user to view the data and input the labels manually through a keyboard, touch screen, microphone, button press, joystick or the like. The provider may be a trained neural network capable of generating labels based on the data, in other words using the data as an input. The provider may be a computer, phone, tablet, micro-controller or the like.

Once the labels have been provided by the provider, they may be stored in a fourth storage in addition to their associated pieces of further data.

In this context the controller is configured to carry out the functions detailed above (steps i-x). First the controller receives a set of labelled data. The controller may receive this set of labelled data from many sources such as a hardware system (i.e., camera, microphone, sensors etc.) or the internet, or an external storage system. The controller is in communication with the first storage and the controller sends the received set of labelled data to the first storage for retention.

The controller is then configured to initially train the task specific engine using the labelled data stored in the first storage. The controller may utilize an algorithm and/or command to determine which of the labelled data to use, (e.g., all of it, part of it). The labelled data that is used for the initial training is termed the training data as detailed above. As the controller initially trains the task specific engine, data associated with the initially trained task specific engine is generated. The controller controls the deposit/retrieval of this data from the second storage. Thus, the controller is in communication with the second storage.

The controller is configured to then input at least part of the labelled data into the initially trained task specific engine, the initially trained task specific engine generating a task specific performance score for each piece of inputted data. The controller may use an algorithm to decide which, if not all, of the labelled data may be inputted into the task specific network. The controller may store the performance scores in the first storage in addition to the training data.

Furthermore, based on the performance scores and a predetermined threshold, the controller is configured to determine which of the pieces of labelled data should be inputted into the embedding engine. Details relating to the thresholding are described above. The controller feeds the identified labelled data into the embedding engine. The embedding engine will then output a low dimension representation of the identified labelled data. Thus, the controller is in communication with the embedding engine.

The controller is then configured to retrieve further data from the receiver. The controller stores the further data in the third storage. The controller then inputs the further data into the embedding engine, the output of the embedding engine being a low dimension representation of the further data. The controller is then configured to determine further data that is similar to the identified labelled data. A description of what is termed similar data is detailed above with respect to the first aspect of the invention. The further data that is determined similar to the identified labelled data is termed the determined further data.

Note that, as previously discussed, some of the determined further data may not have a label associated with it. In this instance the controller will receive, from the provider, a label for the determined further data. The label associated with the determined further day may be stored in addition to the further data in the third storage. Depending on the type of provider, the controller may signal a prompt to notify the provider that a label is required. This signal may be an electronic signal, or a noise, vibration, visual signal, email, SMS or the like. The signal may be designed to prompt a user to provide a label. Once labelled, the determined further data is now referred to as further training data (i.e., further training data comprises both pieces of input data and a corresponding label).

The controller is now configured to further train the initially trained task specific engine using the further training data and/or the initial training data. In order to further train the initially trained task specific engine, the data associated with the initially trained task specific engine may be retrieved from the second storage. The data associated with the initially trained task specific engine may be updated after each further training iteration. Alternatively, new data associated with the further training of the initially trained task specific engine may be generated, updated throughout further training and then stored in addition to the data associated with the initially trained task specific engine. The data generated from the further training of the initially trained task specific engine is termed updated data. As discussed, it is stored by the controller in the second storage.

The controller may be a microcontroller, a FPGA, ASIC, or any combination thereof. It may be software controlled or hardwired.

As is explained above in relation to the first object of the invention, the trained task specific engine may be used in any situation where machine learning is used. The method aims at improving, in a simple manner, the training thereof and thus is not limited to any particular application.

Above, multiple applications are described, and these are equally relevant in this context.

In a first situation, the system further comprises a vehicle with a camera configured to output image data and feed the data to the receiver as further data, the controller being configured to, after step x, receive second image data from the camera, feed the second image data into the task specific engine, receive an output of the task specific engine and operate the vehicle based on the received output.

In a second situation, the system further comprises a camera viewing a moving object, the camera being configured to output image data and feed the data to the receiver as further data, the controller being configured to have step v. comprise receiving, as the further data, first image data from the camera, where the controller is further configured to, after step x, receive second image data from the camera, feed the second image data into the task specific engine, receive an output of the task specific engine and output, based on the received output, information relating to the moving object.

In a third situation, the system further comprises a moving element with a camera configured to output image data and feed the data to the receiver as further data, the controller being configured to have step v. comprise receiving, as the further data, first image data from the camera, where the controller is further configured to, after step x, receive second image data from the camera, feed the second image data into the task specific engine, receive an output of the task specific engine and operate the moving element based on the received output.

In a fourth situation, the system further comprises a camera configured to image each of a plurality of items, output image data and feed the data to the receiver as further data wherein the controller is configured to have step v. comprise receiving, as the further data, first image data from a camera relating to each of a first plurality of items, where the controller is further configured to, after step x, receive second image data from the camera, the second image data relating to each of a second plurality of further items, feed the second image data into the task specific engine, receive an output of the task specific engine and output information, based on the received output, relating to each of the second plurality of further items.

Note that in the first, second, third and fourth aspects of the invention the controller may be configured to carry out steps iii-x multiple times with the aim of iteratively improving the performance of the task specific engine.

As is also described above, the second and third or fourth aspects of the invention may be combined so that the removal of superfluous training data may take place while or around when further data is included.

Then, the processor may further be configured to, after step ii:
input at least part of the training data into the initially trained task specific engine and generate a performance score for each piece of input training data,
identify inputted training data with a performance score above a threshold,
input the identified training data into the embedding engine,
from an output of the embedding engine, determine groups of similar identified training data,
from one or more of the determined groups, establish one or more pieces of the similar identified training data and remove the established pieces of data from the initial training data to generate altered training data,
further train the task specific engine using the altered training data. (may be a retraining using the initial training data and the altered training data)

As mentioned, if the identified inputted labelled data is training data, steps iii. and the first one mentioned immediately above may be the same step, so the description of one may be removed.

The third aspect of the invention relates to a method of training a task specific engine, the method comprising:
a. providing a set of labelled data, the set comprising training data,
b. initially train the task specific engine using the training data to obtain an initially trained task specific engine,
c. input at least part of the training data into the initially trained task specific engine and generate a performance score for each piece of input training data,
d. identify inputted training data with a performance score above a threshold,
e. input the identified training data into an embedding engine, the embedding engine being configured to represent high dimensional data in a low dimensional representation,
f. from an output of the embedding engine, determine groups of similar identified training data,
g. from one or more of the determined groups, establish one or more pieces of the similar identified training data and remove the established pieces of data from the initial training data to generate altered training data,
h. further train the task specific engine using the altered training data. (may be a retraining using the initial training data and the altered training data).

The task specific engine, labelled data, initial training, initially trained task specific network, embedding engine, are all as described above within the first or second aspect of the invention.

Clearly, any embodiment, situation, consideration and the like described in relation to the first or second aspect is equally relevant to the third aspect of the invention.

In this context, the steps a, b, and c, of the method of this aspect of the invention are as described in the section detailing the first aspect of the invention.

In this context the threshold described in step d may be the same threshold as described in the section relating the first aspect of the invention. However, in this context, the identified training data is data that has a performance score above the predetermined threshold value (in contrast to the first aspect of the invention where the identified training data has a performance score of below the predetermined threshold value). Details regarding the threshold value are described above. Thus, the threshold may be determined in any desired manner.

In this context the identified training data is inputted into the embedding engine. The embedding engine represents the high dimensional data in a low dimension representation. The low dimensional presentation of the identified training data enables easier determination of one or more groups of similar data. In this context a group of data may be one or more pieces of the identified training data. To determine the one or more groups of similar data, a clustering algorithm such as density-based, distribution based, Centroid-based, hierarchical-based, k-means or the like may be applied to the low dimensional representation of the identified training data. In general, the similarity is in the lower dimensional representation.

In this context, altered training data is generated by establishing one or more pieces of similar identified training data from the one or more groups of determined groups and removing this established data from the initial training data, thus effectively reducing the number or amount of data in that-or each-group.

Many possible methods exist to determine which pieces of similar identified training data should be removed to generate the altered training data. For example, it may be desirable to remove any duplicate data, i.e., any that has exactly the same low dimension representation. In other words, if two of the data have the same low dimension representation, one could advantageously be removed. Additionally, if more than two, e.g. three, four, five, or more pieces of data all have the same low dimension representation, all but one of the pieces of data could be removed.

In another alternative method, a further clustering algorithm may be applied to the pieces of data within the low dimension representation. Once a group or cluster has been established, it may be that a certain percentage of the group, (e.g., 10, 20, 30%) is removed. The selection of which data to remove from the determined group may be random. Alternatively, it may be a fixed amount of data that is removed, (e.g., one piece, two pieces, five pieces etc.)

In an alternative method, any pieces of data wherein the distance between the data is below a certain value could be a candidate for removal. In this instance, the data within the low dimension representation may be correlated with its performance score output from the task specific engine. Pieces of data with a similar location in the low dimension representation space to a second piece of data, and also have a high-performance score, may be removed.

The method of using the performance score to determine which data to remove may also be applied to the clustering method described above. For example, once a group has been established, only pieces of data with a high-performance score (e.g., above a predetermined threshold, or the like) may be removed from the group.

Removing similar pieces of data with task specific performance scores above the threshold has the benefit of potentially reducing overfitting by the task specific engine. If overfitting occurs, the task specific engine may only be able to output successful matches for data that it has been exposed to during the training and may be unable to generalize to new data.

In this context, further training comprises training the initially trained task specific engine using the altered training data and starting with the initial parameters generated during initial training. An alternative is to retrain the task specific engine using the altered training data and starting with zeroed, randomized or reset parameters associated with the task specific engine.

As this method acts to, in a simple manner, remove superfluous training data, this method is not limited to any particular application. Above, a number of applications are mentioned especially in relation to the first and second objects of the invention. Naturally the third object of the invention would be equally useful for enhancing the training data in those applications.

As mentioned above, the third object of the invention may be combined with any of the first and second objects of the invention to assist, in that context, with the enhancing of the training data.

The fourth aspect of the invention relates to a system for training a task specific engine comprising:
a storage configured to hold a set of labelled data,
a second storage configured to hold data relating to the task specific engine,
a controller configured to:
receive the set of labelled data, the set comprising training data, and storing the labelled data in the first storage.
   ii. initially train the task specific engine using the training data to obtain an initially trained task specific engine and to generate initial data associated with the initially trained task specific engine and store the initial data in the second storage,
   iii. input at least part of the training data into the initially trained task specific engine and generate, for each piece of input training data, a performance score,
   iv. identify training data with a performance score above a threshold and input the identified training data into the pre-trained embedding engine, the embedding engine being configured to represent high dimensional data in a low dimensional representation,
   v. from an output of the embedding engine, determine groups of similar input training data,
   vi. from one or more of the determined groups, establish one or more pieces of the similar identified training data and remove the established pieces of data from the initial training data to generate altered training data,
   vii. further train the initially trained task specific engine using the altered training data, and
   viii. generate updated data associated with the task specific engine and store in the second storage.

The task specific engine, labelled data, initial training, initially trained task specific network, embedding engine, first storage, second storage, third storage, threshold, are all as described above within the first, second or third aspect of the invention.

Clearly, any embodiment, situation, consideration and the like described in relation to the first, second or third aspect is equally relevant to the fourth aspect of the invention.

In this context the controller is configured to perform steps (i to viii) as detailed above with respect to the fourth aspect. Steps i, ii, and iii are as described with relation to the second aspect of the invention.

In this context the controller is configured to identify pieces of initial training data that have a performance score of above a threshold value. The pieces of initial training data with a performance score above the threshold are termed identified training data. The controller is configured to input the identified training data into the embedding engine.

The controller is then configured to, using the low dimension representation of the identified training data outputted from the embedding engine, determine one or more groups of similar identified training data. These determined groups are as detailed above in the third aspect of the invention. The controller is then configured to establish which of the pieces of identified training data should be removed from the determined groups. The controller may use a number of methods to establish the data that is to be removed from the initial training data, these methods are as described above with regards to the third aspect of the invention. The removal of the established data from the initial training data generates altered training data.

The controller is then configured to further train the initially trained task specific engine using the altered data. The controller may retrieve the data relating the initially trained take specific engine from the second storage and use this data as a starting point for the further training. Alternatively, it may retrain the task specific engine, using reset, zeroed or randomized parameters associated with the task specific engine.

Once the further training has finished, the controller is also configured to generate updated data that is associated with the trained task specific engine and store this data in the second storage.

As is the situation for the third object of the invention, this object may be combined with the first and second objects of the invention if desired and may be used in combination with any of the applications described above.

### BRIEF DESCRIPTION OF THE DRAWINGS

In the following, preferred embodiments will be described with reference to the drawing, wherein:

FIG. 1 illustrates relevant steps in relation to the training of a task specific network 2 by the addition of selected data similar to poorly performing validation data.

FIG. 2 illustrates relevant steps in relation to the training of a task specific network 2 by the removal of redundant but well performing validation data and retraining on the remaining validation data.

FIG. 3 shows an example system associated with the invention.

FIG. 4 shows an alternative version of the system, associated with the method depicted in FIG. 2.

### DETAILED DESCRIPTION OF THE INVENTION

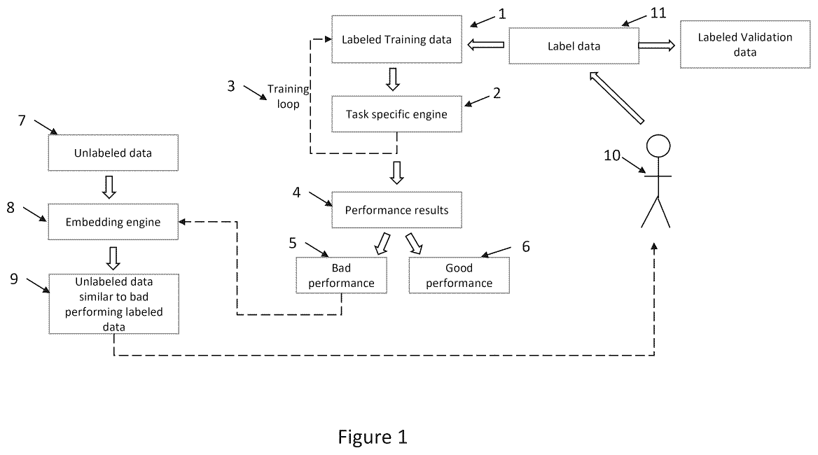

FIG. 1 shows the process for a preferred embodiment of the invention. In the preferred embodiment the task specific engine 2 is trained, using training data 1, in order to be able to classify subsequent other data of the same type. In other words, the task specific engine 2 may sort entered data into different categories depending on features of the data. The operation of the network 2 and the selected features may not be obvious to a human.

In alternative embodiments, the task specific engine could be used for purposes other than classification, such as robotic control systems, natural language processing, stock market prediction, weather prediction, system modelling, system control or the like.

The task specific engine 2 may be a recurrent neural network, a convolutional neural network, a transformer neural network, a deconvolutional neural network, a modular neural network or the like. The task specific engine may utilize hidden layers if desired. The type of the task specific engine may be dependent on the task. Moreover, the size of the neural network, such as the number of inputs/outputs, hidden layers, nodes in each layer, may be dependent on the desired task. Methods and techniques of determining the appropriate size and type of neural network for a particular task are known to those skilled in the art.

In an alternative embodiment the task specific engine may utilize different machine learning approaches such as support vector machines, random decision forests, cascade classifiers, logistic regression, naïve bayes, K-Nearest Neighbors or the like.

The training data could be a plurality of images, videos, sound data, text, text-based instructions, non-text-based instructions, CAD files, sensor data, mathematical functions, coordinates or the like. The number of individual pieces of training data may vary depending on the task at hand. Methods and techniques of determining the minimum size of the training data set for a particular task are known to those skilled in the art. Moreover, it is known that a larger training data set with greater variance in data will results in a more robust neural network.

To train the task specific engine, in addition to the training data, a corresponding label set 11 is provided. In at least one dimension the size of the label set is equal to the size of the training data. In other words, each piece of training data has an equivalent label. In some applications it may be necessary to have more than one type of label for each piece of training data. The label may be considered a way of annotating the equivalent data. The label may be text, image, sound, a bounding box, a segmentation mask or the like. It may also be a combination of the text, image, sound, a bounding box, a segmentation mask or the like.

For example, in one application, where the training data is the form of an image, the label may be a text string annotating whether a human is present in the image or not. Furthermore, the label may also contain coordinates as to the location of the human in the image. Furthermore, the label may also contain a text string describing the stance of the person. Furthermore, the label may also contain a text string describing the hair color of the person.

In another example, in an alternative application where the training data is in the form of sound data, wherein the sound is a recording of machinery, the label may be in the form of a text string annotating if the machine is faulty. Furthermore, the label may also include the type of fault. Furthermore, the label may also include the location of the fault within the machine. Furthermore, the label may also include at what time stamp throughout the sound data sample the fault was most recognizable. In this example the human may be required to listen to the sound clip of the machine and write the label themselves to determine the fault. Moreover, the human could compare the sound clip with other sensor data installed on the machine, such as a temperature sensor, a pressure sensor, a leak detector or the like and from the additional sensor data determine an appropriate label to generate. Training data could also be extracted automatically or by a human from subsequent maintenance records of the machinery.

In another example in an alternative application, wherein the training data is pressure sensor data for a tactile robotic end effector, for gathering and labelling the training data it may also be required for the robot to gather video data. A human may then watch the video data and label the pressure sensor data depending on what is observed in the video. The label may be a text string of the object interacted with by the robotic end effector. Furthermore, the label may also include a time stamp of when the object is touched. In an alternative embodiment, the robot may also contain technology such as a near-field communication sensor capable of detecting a near-field communication label attached to the object being touched. Therefore, such training data may be used to generate labels without human intervention.

It is traditional that the label data is generated manually (human labeler 10). It may also be generated through use of an existing artificial intelligence or using augmented training data. For example, in an instance where the task specific neural network is to recognize humans from an image, a piece of training data with corresponding label may be artificially recolored, i.e., generating a second piece of training data but with the same label as the first piece of training data. In another example a further pre-trained neural network that has been trained to caption images could be used to generate labels for data. Alternatively, corresponding text and labels may be automatically generated by mining publicly available data, such as websites that are published in multiple languages, existing literature, etc.

Moreover, in an alternative application the technology may be used for purposes other than training classification networks. For instance, in an alternative embodiment the task specific engine may be required to translate text from one language to another. In this instance the training data would be text in one language and the label would be text in another language. The training data may be sound data of someone talking in one language and the corresponding label would be sound data in the other language. The training data may be a sound clip and the label a text string or vice versa. To general the label a bilingual speaker may be required to read or listen to the training data and speak or write the translations, i.e., the label.

In another example, in an alternative application the where the training data is in the form of instructions that a robot should follow to achieve a determined location of its end effector, the label may be the location of the end effector. This label could be text string of the coordinates. Alternatively, the label could be a picture of the robot wherein the location of the end effector could be determined. Alternatively, the labels may be a vector of numbers describing the location of the end effector. The labels may be generated by a human, or may be generated algorithmically from knowledge of the robot kinematics, the position and imaging characteristics of a camera that is regarding the robot, etc.

Furthermore, in another alternative application, the task specific engine may be required to predict the weather based on the weather data from the previous days. In this instance the training data may be the temperature and wind speed of five subsequent days and the label would be the temperature and wind speed on the 6th day. In this application a human would not necessarily be required to provide a label.

In the preferred embodiment, the training data and corresponding training labels may be then used to train the task specific engine. In other words, the output of the engine may be compared to the training label data and, if the engine is a neural network, the weights of the task specific engine adjusted within a training loop, 3, until there is a good match between the training label data and the output of the engine for a sufficient portion of the, such as the entire, training data set. The match between the training label data and the output of an engine is often quantized by a loss function. In the case of the engine being a neural network, various loss functions exist, including Mean Squared Error, Mean Absolute Error, Binary Cross-Entropy/Log Loss, Categorical Cross-Entropy Loss and the like. Methods for training neural networks include gradient descent, ADAM, evolutionary algorithms, Krylov method, Stochastic Gradient descent, momentum, Adagrad, and AdaDelta. An appropriate training method/loss function to use for a particular task could be selected by someone skilled in the art. Other machine learning methods such as evolutionary algorithms, evolutionary systems or the like may also be used.

In the subsequent step of the embodiment, the training data, and/or other labelled data is inputted into the initially trained engine. This may be termed the testing results.

The testing results may then be further split into individual pieces data that have a good performance (group 6) between the output of the trained task specific engine and the corresponding data label and those that have a bad performance (group 5). The split could occur based on a threshold. This threshold may be determined in a number of manners, such as based on loss function values. The groups need not be mutually exclusive as indicated. The threshold for groups 5 and 6 may be individually selected.

Then, loss function values of the testing results that are higher than the group 5 threshold value may be sorted into the bad performance group. The threshold value may be fixed, or it may be adaptable based on the standard deviation and/or percentage quartiles of the loss function or the like. Furthermore, it may be adapted depending on how many times the task dependent engine has been trained.

In a further step of the preferred embodiment, the bad performance group are inputted into an embedding engine 8. An embedding engine, which may also be referred to as a clustering engine, dimension reduction engine or the like, allows complex non-linear data sets to be separated and grouped depending on salient features. In other words, an embedding engine may be used to translate high dimension vectors into lower dimension vectors. Data with similar salient features will be closer together in the lower dimension vector space.

Examples of embedding engines are algorithmic embedding engines, such as T-SNE and U-Map. Additionally, embedding engines may be based on artificial neural networks or other ML approaches that are trained by contrastive learning to embed their respective inputs into a lower-dimensionality space. The artificial neural network may be a convolutional neural network. In the instance of the artificial neural network, the embedding engine may be trained to minimize a contrastive loss function. Alternatively, the neural embedding could be based on the latent space of a an autoencoder. In the case of an autoencoder, the full network may be trained to maximize similarity between input and output, and the embedded representation is derived from a reduced-dimensional internal representation from which the output is generated. Moreover, the embedding engine may be a self-supervising transformer. Many embedding engines exist and may be integrated into such a system by those skilled in the art.

Thus, the bad performance group data may be inputted to the embedded engine along with a large amount of unknown (to the task specific engine) data. Note that this unknown data may also be unlabeled. Then, the embedded network may group, in the lower dimension space, pieces of bad performance data along with similar data from the large amount of further data. In other words, two pieces of data that are similar will have a low distance between them in the low dimension representation. Determining distances in any dimensionality may be rather simple. Example methodologies of determining distances may be Euclidian distance, cosine difference, hamming distance, Manhattan, Minkowski, or the like.

There are many alternative methods to determine which of the similar data to extract from the large amount of unknown data. Clustering algorithms exist and are known to those skilled in the art. Examples of clustering algorithms include density-based, distribution based, Centroid-based, hierarchical-based, k-means or the like. Therefore, a possible method to extract new data from the large amount of further data could be to extract everything in a cluster, wherein the cluster includes a piece of low performing training data.

Alternatively, a percentage of the cluster may be extracted from the large amount of unknown data. This may be 10%, 20%, 30%, 40%, 50%, 60%, 70%, 80%, 90% or the like. Out of the cluster, the data may be selected randomly. Alternatively, it may be selected based on the distance to the low performance testing data; data that have lower distance values may be selected, alternatively it may be data with high distance values within the cluster that may be selected.

An alternative method to using a cluster is to simply extract pieces of data from the large amount of further data that have a distance below a predetermined value, or between two predetermined threshold values, to the low performance testing data. Depending on the amount of data this would yield, a percentage of this data could be extracted.

The similar data from the large amount of further data may then be extracted and if necessary labelled. The labelling may be a manual labelling. Alternatively, the similar data may be labelled using artificial intelligence methods or other methods as detailed above. The now labelled similar data may then be added to the training data group. The task specific engine may then be retrained using the updated training group data with the aim of achieving better performance.

A large amount of further data may be obtained via the internet. This is most relevant if the training data type is images or videos. It may also be relevant for some applications utilizing sound as the training data. The amount of the large amount of further data may be greater than the amount of training. For example, it may be 5 times greater, 10 times greater, 20 times greater or 100 times greater or the like.

Alternatively, the further data may stem from an application using the task specific engine, as the engine under normal use requires the input of data of the same type in order to output data consistent with the training of the engine. Thus, the data finally to be analyzed or received by the engine may also be used as the further data.

If the application requires it, it may be the case that more data must be generated/collected rather than sourced from, for example the internet. In this instance the output from the embedded engine may indicate the type of data, i.e., with features close to that of the badly performing group data required to be collected. It may also be linked to a controller that enables this type of data to be collected. For example, if it was found that the bad performing group all contained out of focus images, the controller may control a camera to un-focus the lens to collect more data.

There is another situation wherein the large amount of further data may come from, for example, other robots operating in the field. If the task specific engine was to determine areas that needed cleaning, and there were a number of robots already carrying out the cleaning task, these robots may send images and/or videos back to a central server to be used for further training. It is likely that someone skilled in the art could conceive similar examples where the use of this methodology would be advantageous.

Thus, the final training of the task specific engine will be improved, as the further training takes place with data similar to data on which the engine performs badly.

It may be the case that at this point the success of the trained task specific engine is validated using a previously unseen data set, the validation data set. The validation data set has the same data type and same types of labels as the training data. The validation data is not used for training the task specific engine. In other words, the task specific network does not see the validation data during training. Using validation data after the training of the network tests how well the task specific engine can generalize and that it has not simply memorized the training data.

Note that it may be the case that some of the extracted similar data may be added to the validation data instead of the training data set. The amount of extracted similar data added to the validation data may be a percentage of the overall amount of extracted similar data. The specific data may be randomly selected from the overall amount of extracted similar data until the correct amount is achieved. A person skilled in the art may be able to determine an appropriate percentage.

Naturally, as the similarity is determined in the lower dimensional space, some of the determined further data may be irrelevant so that it may not increase the quality of the training, but as long as some of the further data is relevant, the further training is relevant.

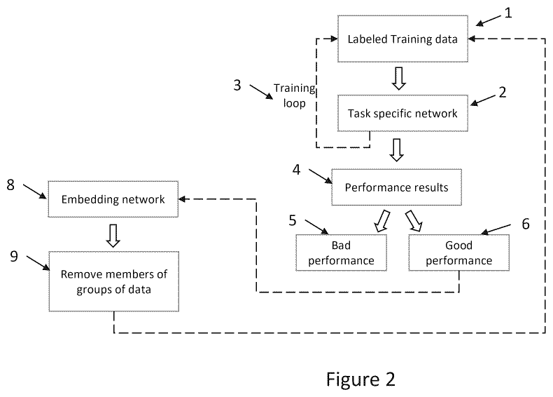

In a rather different embodiment, illustrated in FIG. 2, after the initial training of the task specific engine and based on now the good performance group 6 of the training data, this group may be inputted into the embedding engine 8.

The embedding engine 8 then generates a representation in the lower dimension space that would often comprise groups of the well performing data. A grouping of such data indicates that a number of training data represent similar information and thus present redundant data.

Then, one or more pieces of good performing data from a group of data in the lower dimension representation may be removed to limit the amount of redundant data. The remaining good performing training data may then be used with the task specific engine to further train this engine. This may have the benefit of reducing the risk of over training the task specific engine.

As described before, determining distances in any dimensionality may be rather simple. Example methodologies of determining distances may be Euclidian distance, cosine difference, hamming distance, Manhattan, Minkowski, or the like.

Then, two pieces of data may be assumed to be similar if the distance between their representations in the lower dimensional space (as generated by the embedding engine) is below a threshold distance.

There are many alternative methods that may be used to determine which of the good performance group data to remove based on the low dimension representation output from the embedding engine. For example, it may be desirable to remove any duplicate data, i.e., any that has the same position in the low dimension representation. In other words, if two of the data have the same position, one could advantageously be removed. Additionally, if more than two, e.g. three, four, five, or more pieces of data all have the same position in the low dimension representation, all but one of the pieces of data could be removed.

In an alternative method, if there is a piece of data in the low dimension representation that has a distance greater than a predetermined threshold, i.e., it is very far from any of the other data within the representation it may be considered irrelevant to the specific task and therefore could advantageously also be removed as it may be causing false overfitting. For example, if the task specific network is evaluating images from a camera to assess the quantity of grain in a hopper, and training labels are generated automatically by a special hopper that includes a scale to independently measure the weight of its contents, occasionally training images may be generated in which the camera view is obscured by a piece of debris, a passing bird, etc. In this case the obscured image might project to a very different part of the embedding space than the other images.

In another alternative method, a further clustering algorithm may be applied to the pieces of data within the low dimension representation. Once a cluster or group has been established, it may be that a certain percentage of the cluster, (e.g., 10, 20, 30%) is removed. The selection of which data to remove from the determined cluster may be random. Alternatively, it may be a fixed amount of data that is removed, (e.g., one piece, two pieces, five pieces etc.)

In an alternative method, any pieces of data wherein the distance between the data is below a certain threshold could be a candidate for removal. In this instance, the data within the low dimension representation may be correlated with its performance score output from the task specific neural network. Pieces of data with a similar location in the low dimension representation to a second piece of data, and also have a high-performance score, may be removed.

The method of using the performance score to determine which data to remove may also be applied to the clustering method described above.

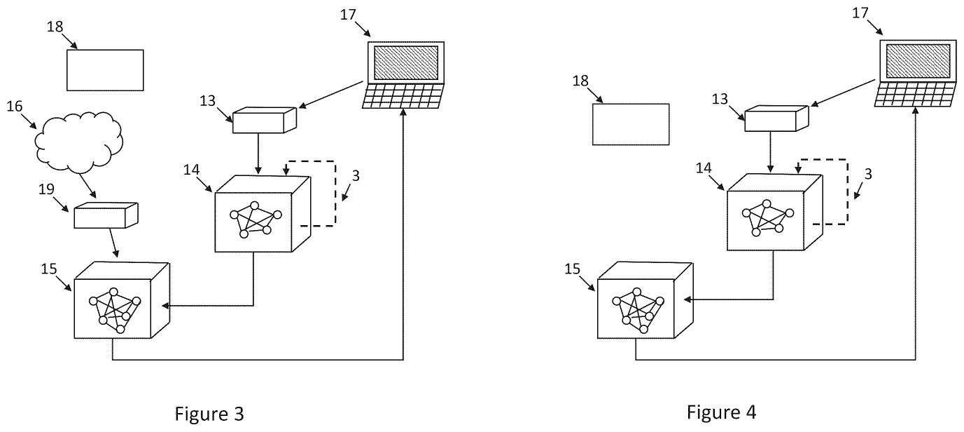

FIG. 3 shows an example system associated with the invention. The system may comprise a first storage area 13 which stores the training data. It may also be used to store validation if this is to be used (as described above). The first storage area may be a physical hard drive, a disk drive, USB drive or it could be a virtual storage area, for example on the internet in the cloud or such like. The label data associated with the training data and/or validation data may also be stored here.

The system may also comprise a second storage area 14. The second storage area may be used to store data relating to the task specific engine. The second storage area may be a physical hard drive, a disk drive, USB drive or it could be a virtual storage area, for example on internet in the cloud or such like. The system may use storage associated with a GPU, CPU or TPU depending on the type of task specific network in use. Examples of data stored within the second storage area may be morphology of a neural network, including locations of nodes and connections etc. Examples of data stored in the second storage may also be the weights of connections and any bias values if used. The data stored in the second storage area may be temporary and for example updated during the training phase (loop, 3) of the task specific engine. Note that the first and second storage may be the same, for instance, both training data and network weights might be stored in the cloud.

The system may further comprise a third storage area 15. The third storage area may be used to store data relating to the embedding engine. The third storage may be a physical hard drive, a disk drive, USB drive or it could be a virtual storage area, for example on the internet in the cloud or such like. The system may use storage associated with a GPU, CPU or TPU. Examples of data stored within the third storage area may be morphology of an embedding engine, including locations of nodes and connections etc. The data may also be the weights of connections and any bias values if used. As mentioned in the previous paragraph, the third, second and first storage may all be the same, i.e., all the data is stored on the cloud.

Alternatively, the third and second storage may be the same and the data associated with the first storage stored elsewhere.

The system may also comprise a means for receiving further data that is to be utilized by the embedding engine. This means for receiving further data could be the internet. This means for receiving further data could be a separate storage system, that is much larger than the first storage system. This means for receiving further data could be a separate piece of hardware such as a camera, microphone, sensor or the like. This means for receiving further data could be a plurality of pieces of hardware.

There may also be a means for receiving labels for unlabeled data comprised in the system 17. This may be a user interface allowing a user to view the data and input the labels manually through a keyboard, touch screen, microphone, button press, joystick or the like. It may be a trained neural network capable of generating labels based on the data, in other words using the data as an input. It may be a computer, phone, tablet, micro-controller or the like.

There may also be a fourth storage for holding the further data that is received from the means for receiving further data. It may be a physical hard drive, a disk drive, USB drive or it could be a virtual storage area, for example on the internet in the cloud or such like. The fourth storage area could be the same as the first and/or second and/or third storage areas.

The system may also comprise a controller 18. The controller may be configured to carry out the methods described above. Therefore, the controller may receive a set of labelled training data and store the set in the first storage. The controller may receive this data from many sources such as a hardware system (i.e., camera, microphone, sensors etc.) or the internet, or an external storage system.

The control system may then initially train the task specific engine using the training data to obtain an initially trained task specific engine. Any generated initial data associated with the initially trained task specific engine may be stored in the second storage.

The controller may then re-input the training data and/or input other labelled data into the initially trained task specific engine and generate a performance score for each piece of training data.

The controller may then, from the third storage area retrieve the data associated with the pre-trained embedding engine. The controller may then input the training/labelled data with a performance score below a threshold into the pre-trained embedding engine, the embedding engine being configured to represent high dimensional data in a low dimensional representation. The controller may also receive and store the unlabeled data in the fourth storage area, it may then also input the further data into the pre-trained embedding engine.

Note that if any of the storage areas comprise memory associated with a TPU, for example, the controller may not have to retrieve this data. Instead, the controller may simply coordinate the processing of the data by the embedding network.

From an output of the embedding engine, the controller may then determine unlabeled data similar to the labelled data with a performance score below the threshold. Moreover, it may be beneficial for the system to utilize a user interface to depict the low dimensional output of the pre-trained embedding network, such that a user may observe the similar data and select/deselect the data. Additionally, it may be beneficial to have a fifth storage area to store the low dimensional output of the pre-trained embedding engine, the fifth storage area taking a form similar to the first and fourth storage areas.

The controller may then receive labels, from the means for receiving labels, labels for the determined unlabeled data so as to label the determined unlabeled data, and thus generate further training data. The controller may then input the further training data into the initially trained task specific engine to further train the initially trained task specific engine and thus it may then generate updated data associated with the task specific engine and store the updated data in the second storage.

FIG. 4 shows an alternative version of the system, associated with the method depicted in FIG. 2. In this system it may not be necessary to utilize the means for receiving further data and the fourth storage area. Instead in this instance the controller may be first configured to first receive the set of labelled data, the set comprising training data and store it in the first storage area.

The control system may then initially train the task specific engine using the training data to obtain an initially trained task specific engine. Any generated initial data associated with the initially trained task specific engine may be stored in the second storage.

The controller may then re-input the training data into the initially trained task specific engine and generate a performance score for each piece of training data.

The controller may then, from the third storage area retrieve the data associated with the pre-trained embedding engine. The controller may then input the training data with a performance score above a threshold into the pre-trained embedding engine, the embedding engine being configured to represent high dimensional data in a low dimensional representation.

The controller may then determine groups of similar training data, based on the output from the pre-trained embedding engine and then it may remove one or more of the members to generate altered training data. This altered training data may then be stored in the first storage area.

The controller may then further train the initially trained task specific engine using the altered training data, and then it may generate updated data associated with the task specific engine and store in the second storage.

1. A method of training a task specific engine, the method comprising
a) providing a set of labelled data, the set comprising training data;
b) initially train the task specific engine using the training data to obtain an initially trained task specific engine;
c) input at least part of the labelled data into the initially trained task-specific engine and generate a performance score for each piece of input labelled data;
d) identify inputted labelled data with a performance score below a threshold and input the identified labelled data into a pre-trained embedding engine, the embedding engine being configured to represent high dimensional data in a low dimensional representation;
e) input further data into the embedding engine;
f) from an output of the embedding engine, determine further data similar to the identified labelled data);
g) obtaining labelling for each determined further data to generate further training data comprising the determined further data and the labelling for it;
h) further train the task specific engine using the further training data.

2. A method according to claim 1, wherein step e) comprises receiving, as the further data, first image data from a camera of a vehicle, where the method further comprises, after step h), the steps of receiving second image data from the camera, feeding the second image data into the task specific engine, receiving an output of the task specific engine and operating the vehicle based on the received output.

3. A method according to claim 1, wherein step e) comprises receiving, as the further data, first image data from a camera imaging a moving object, where the method further comprises, after step h), the steps of receiving second image data from the camera, feeding the second image data into the task specific engine, receiving an output of the task specific engine and outputting, based on the received output, information relating to the moving object.

4. A method according to claim 1, wherein step e) comprises receiving, as the further data, first image data from a camera of a moving element, where the method further comprises, after step h), the steps of receiving second image data from the camera, feeding the second image data into the task specific engine, receiving an output of the task specific engine and operating the moving element based on the received output.

5. A method according to claim 1, wherein step e) comprises receiving, as the further data, first image data from a camera of each of a plurality of items, where the method further comprises, after step h), the steps of receiving second image data from the camera, the second image data relating to each of a plurality of further items, feeding the second image data into the task specific engine, receiving an output of the task specific engine and outputting information, based on the received output, relating to each of the further items.

6. A method according to claim 1 further comprising, after step b), the steps of:
input at least part of the training data into the initially trained task specific engine and generate a performance score for each piece of input training data;
identify inputted training data with a performance score above a threshold;
input the identified training data into an embedding engine, the embedding engine being configured to represent high dimensional data in a low dimensional representation;
from an output of the embedding engine, determine groups of similar identified training data;
from one or more of the determined groups, establish one or more pieces of the similar identified training data and remove the established pieces of data from the initial training data to generate altered training data;
further train the task specific engine using the altered training data.

7. A system for training a task specific engine comprising:
a storage configured to hold a set of labelled data;
a second storage configured to hold data relating to the task specific engine;
a receiver configured to receive further data;
an embedding engine configured to represent high dimensional data in a low dimension representation;
a third storage configured to hold the further data;
a provider configured to provide labels for data; and
a controller configured to:
i) retrieve the labelled data from the first storage and determine a set of initial training data from at least part of the labelled data;
ii) initially train the task specific engine using the initial training data to obtain an initially trained task specific engine and to generate initial data associated with the initially trained task specific engine; and store the initial data in the second storage;
iii) input at least part of the labelled data into the initially trained task specific engine and generate, for each input labelled data, a performance score;
iv) identify the labelled data with a performance score below a threshold and input the identified labelled data into the pre-trained embedding engine, the embedding engine being configured to represent high dimensional data in a low dimensional representation;
v) receive and store the further data in the third storage;
vi) input the further data into the pre-trained embedding engine;
vii) from an output of the embedding engine, determine further data similar to the identified labelled data;
viii) receive, from the provider, labels for the determined further data, and generate further training data from the labels and the determined further data;
ix) further train the trained task specific engine using the further training data;
x) generate updated data associated with the further trained task specific engine and store the updated data in the second storage.

8. A system according to claim 7, the system further comprising a vehicle with a camera configured to output image data and feed the data, in step vi), to the receiver as further data, the controller being configured to, after step x), receive second image data from the camera, feed the second image data into the task specific engine, receive an output of the task specific engine and operate the vehicle based on the received output.

9. A system according to claim 7, the system further comprising a camera viewing a moving object, the camera being configured to output image data and feed the data to the receiver as further data, the controller being configured to have step v) comprising receiving, as the further data, first image data from the camera, where the controller is further configured to, after step x), receive second image data from the camera, feed the second image data into the task specific engine, receive an output of the task specific engine and output, based on the received output, information relating to the moving object.

10. A system according to claim 7, the system further comprising a moving element with a camera configured to output image data and feed the data to the receiver as further data, the controller being configured to have step v) comprising receiving, as the further data, first image data from the camera, where the controller is further configured to, after step x), receive second image data from the camera, feed the second image data into the task specific engine, receive an output of the task specific engine and operate the moving element based on the received output.

11. A system according to claim 7, the system further comprising a camera configured to image each of a plurality of items, output image data and feed the data to the receiver as further data wherein the controller is configured to have step v) comprising receiving, as the further data, first image data from a camera relating to each of a first plurality of items, where the controller is further configured to, after step x), receive second image data from the camera, the second image data relating to each of a second plurality of further items, feed the second image data into the task specific engine, receive an output of the task specific engine and output information, based on the received output, relating to each of the second plurality of further items.

12. A system according to claim 7, where the processor is further configured to, after step ii):
input at least part of the training data into the initially trained task specific engine and generate a performance score for each piece of input training data;
identify inputted training data with a performance score above a threshold;
input the identified training data into the embedding engine;
from an output of the embedding engine, determine groups of similar identified training data;
from one or more of the determined groups, establish one or more pieces of the similar identified training data and remove the established pieces of data from the initial training data to generate altered training data;
further train the task specific engine using the altered training data.

13. A method of training a task specific engine, the method comprising:
a) providing a set of labelled data, the set comprising training data;
b) initially train the task specific engine using the training data to obtain an initially trained task specific engine;
c) input at least part of the training data into the initially trained task specific engine and generate a performance score for each piece of input training data;
d) identify inputted training data with a performance score above a threshold;
e) input the identified training data into an embedding engine, the embedding engine being configured to represent high dimensional data in a low dimensional representation;
f) from an output of the embedding engine, determine groups of similar identified training data;
g) from one or more of the determined groups, establish one or more pieces of the similar identified training data and remove the established pieces of data from the initial training data to generate altered training data; and
h) further train the task specific engine using the altered training data.

14. A system for training a task specific engine comprising:
a storage configured to hold a set of labelled data;
a second storage configured to hold data relating to the task specific engine;
a controller configured to:
i) receive the set of labelled data, the set comprising training data, and storing the labelled data in the first storage;
ii) initially train the task specific engine using the training data to obtain an initially trained task specific engine and to generate initial data associated with the initially trained task specific engine and store the initial data in the second storage;
iii) input at least part of the training data into the initially trained task specific engine and generate, for each piece of input training data, a performance score;
iv) identify training data with a performance score above a threshold and input the identified training data into an embedding engine, the embedding engine being configured to represent high dimensional data in a low dimensional representation;
v) from an output of the embedding engine, determine groups of similar input training data;
vi) from one or more of the determined groups, establish one or more pieces of the similar identified training data and remove the established pieces of data from the initial training data to generate altered training data;
vii) further train the initially trained task specific engine using the altered training data; and
viii) generate updated data associated with the trained task specific engine and store in the second storage.
